(19) United States
(12) Patent Application Publication
(10) Pub. No.: US 2026/0015008 A1
(43) Pub. Date: Jan. 15, 2026

(54) Vehicle Positioning Using Surface and Subsurface Patterns

(71) Applicants: Vladimir IVAKHNENKO, Norton, MA (US); GPR, Inc., Somerville, MA (US)

(72) Inventors: Vladimir IVAKHNENKO, Norton, MA (US); Byron STANLEY, Newton, MA (US)

(73) Assignee: GPR, Inc., Somerville, MA (US)

(21) Appl. No.: 18/995,035

(22) PCT Filed: Jul. 21, 2023
(86) PCT No.: PCT/US2023/070750

§ 371 Date: Jan. 15, 2025

Related U.S. Application Data
(60) Provisional application No. 63/391,510, filed on Jul. 22, 2022.

(51) Int. Cl. B60W 60/00; G01S 13/931

(52) U.S. Cl. CPC B60W 60/001; G01S 13/931; B60W 2420/408; G01S 2013/9329

(57) ABSTRACT

A positioning system for a vehicle having a radar antenna array and a radar operating system, the radar antenna array transmitting and receiving radar signals and the radar operating system (i) driving the antenna arrays to emit radar signals and receive reflection signals from a reflective pattern located beneath the vehicle and (ii) analyzing the received reflection signals to ascertain a vehicle position relative to the reflective pattern.

### CROSS-REFERENCE TO RELATED APPLICATIONS

This application claims the benefit of U.S. Provisional Patent Application No. 63/391,510 filed Jul. 22, 2022 entitled “Vehicle Positioning Using Surface and Subsurface Patterns”, which is incorporated by reference herein in its entirety.

### TECHNICAL FIELD

The present invention relates, generally, to vehicle positioning and, more particularly, to positioning a vehicle using radar reflections from the ground or other surface.

### BACKGROUND

Vehicle positioning is challenging for human drivers and more so for systems that attempt to automate positioning tasks such as parking, changing lanes during travel or maneuvering an electric vehicle over a charging surface. Current solutions tend to involve LiDAR sensors (which can measure vehicle distances to fixed points such as curbs or guardrails) and optical cameras (which, with computer vision support, can detect and identify objects and measure distances). While suitable in many circumstances, such approaches are vulnerable to failure in adverse environmental conditions, e.g., if snow covers a lane marker or a feature used for navigation is moved.

Accordingly, there is a need for approaches to vehicle positioning and maneuvering that are resilient to changes in environmental conditions and do not depend on fixed features that may not be visible or permanent.

### SUMMARY

In certain embodiments, a vehicle positioning system for a vehicle may comprise a radar antenna array and a radar operating system. The radar antenna array may be configured to transmit and receive radar signals; and the radar operating system may (i) drive the antenna arrays to emit radar signals and receive reflection signals from a reflective pattern located beneath the vehicle and (ii) analyze the received reflection signals to ascertain a vehicle position relative to the reflective pattern.

In certain embodiments, the system may further comprise a vehicle operating system, that responsive to the radar operating system, moves the vehicle into a desired position relative to the reflective pattern. In certain embodiments, the reflective pattern may comprise a plurality of parallel stripes angled with respect to a direction of travel of the vehicle. In certain embodiments, the parallel stripes may include long and short lengths sensitive to different radar frequencies or harmonics thereof. In certain embodiments, the long and short lengths alternate across the reflective pattern. In certain embodiments, the parallel stripes have a length substantially equal to a dominant wavelength of the radar signals or fraction thereof.

In certain embodiments, the parallel stripes may be disposed on a surface over which the vehicle travels. In certain embodiments, the stripes may be disposed below a surface over which the vehicle travels. In certain embodiments, the stripes may include metallic strips. In certain embodiments, the parallel stripes are conductive paint.

In certain embodiments, a method of positioning a vehicle on a travel surface may comprise the steps of: transmitting radar signals toward a reflective pattern and receiving reflections signal therefrom; and computationally guiding the vehicle to a desired position by causing the vehicle to move over the reflective pattern and, there during, computationally analyzing the received reflection signals to ascertain a vehicle position relative to the reflective pattern and responsively altering a path of the vehicle to achieve the desired position.

In certain embodiments, the reflective pattern may comprise a plurality of parallel stripes angled with respect to a direction of travel of the vehicle. In certain embodiments, the parallel stripes may include long and short lengths sensitive to different radar frequencies or harmonics thereof. In certain embodiments, the long and short lengths may alternate across the reflective pattern. In certain embodiments, the parallel stripes may have a length substantially equal to a dominant wavelength of the radar signals or fraction thereof.

In certain embodiments, the parallel stripes may be disposed on a surface over which the vehicle travels. In certain embodiments, the parallel stripes may be disposed below a surface over which the vehicle travels. In certain embodiments, the parallel stripes may include metallic strips. In certain embodiments, the parallel stripes may include conductive paint.

### BRIEF DESCRIPTION OF THE DRAWINGS

The foregoing summary, as well as the following detailed description of embodiments of the system, will be better understood when read in conjunction with the appended drawings of an exemplary embodiment. It should be understood, however, that the invention is not limited to the precise arrangements and instrumentalities shown.

FIG. 1 schematically depicts an exemplary surface penetrating radar (SPR) system in accordance with embodiments of the invention;

FIG. 2A is a side view of a vehicle including the SPR system of FIG. 1;

FIG. 2B is a front view of a vehicle including the SPR system of FIG. 1; and

FIG. 3 is a top view of a reflective pattern in accordance with embodiments of the invention.

### DESCRIPTION

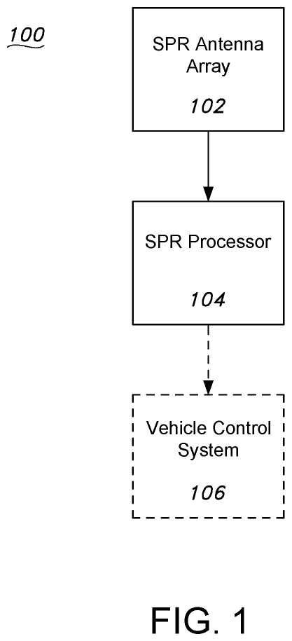

In accordance with embodiments of the present invention, a vehicle is equipped with an array of radar antennas, such as a surface-penetrating radar (SPR) array. SPR has been used for vehicle navigation and related purposes, and is well-suited to deployments involving vehicle positioning. With reference to FIG. 1, a representative mobile SPR system 100 may include a SPR antenna array 102, which, as detailed below, may be mounted to the underside of a vehicle. The SPR antenna array 102 may include one or more antenna elements for transmitting and receiving radar signals. A conventional SPR processor 104 may control the transmit operations of the SPR antenna array 102 and may receive return radar signals for analysis. In various embodiments, the detected SPR signals may be processed to generate one or more SPR images of the surface and/or subsurface region along the track of the vehicle to which the antenna array 102 is mounted. Suitable SPR antenna configurations and systems for processing SPR signals are described, for example, in U.S. Pat. No. 8,949,024, the entire disclosure of which is hereby incorporated by reference.

For certain applications, such as navigation, the SPR images may be compared to SPR reference images that were previously acquired and stored for subsurface regions that at least partially overlap the subsurface regions for the defined route. The image comparison may be a registration process based on, for example, correlation; see, e.g., U.S. Pat. No. 8,786,485, the entire disclosure of which is incorporated by reference herein. The location of the vehicle and/or the terrain conditions of the route may then be determined based on the comparison. Although the present invention may be combined with navigation—e.g., to guide a vehicle to the nearest charging station and position it over a coil—the functions may further involve vehicle maneuvering over short distances. A vehicle control system 106 may be a conventional system capable of safely guiding the vehicle as described herein. The system 106 may operate autonomously or may provide signals to a human driver.

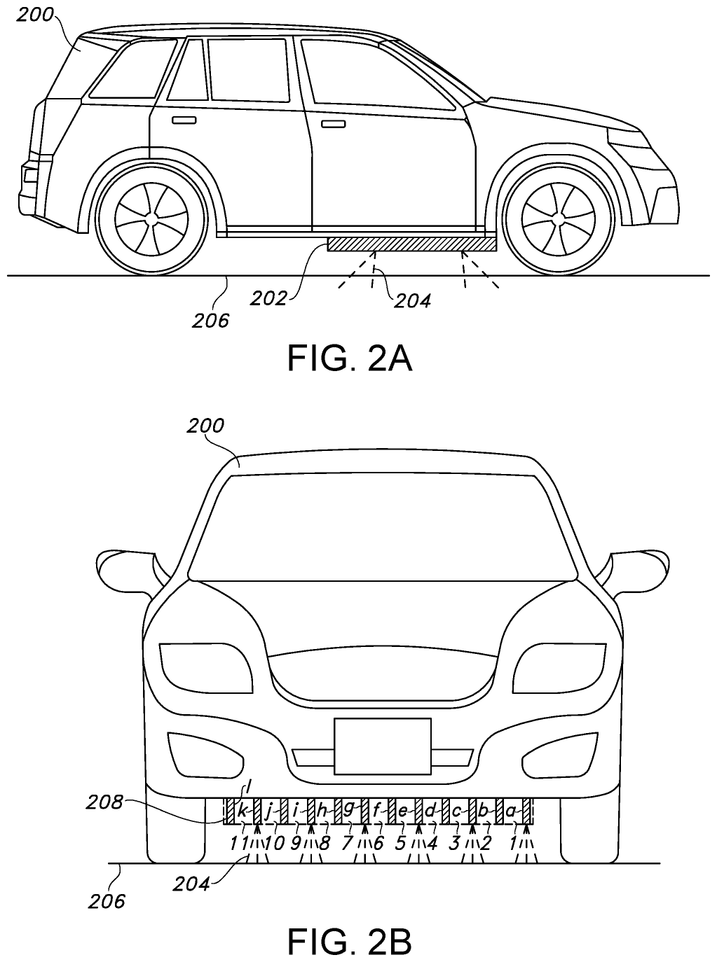

With reference to FIGS. 2A and 2B, a vehicle 200, which may be any mobile platform or structure, may include a SPR system 202 that transmits SPR signals 204 from a plurality of SPR transmit elements as shown in FIG. 2B. The antenna array 208 may include, illustratively, a linear configuration of 12 spatially invariant transmit and receive antenna elements a through 1 for transmitting and receiving SPR signals 204. The antenna array 208 may include a non-linear configuration of spatially invariant transmit and receive antenna elements. The twelve antenna elements may form eleven channels 1-11. Each channel may include a transmit and a receive element. Each channel may include a transmit and a receive pair. In some embodiments, antenna elements are included on the front bumper of the vehicle 200 to detect guiding elements. In some embodiments, antenna elements are included under the front bumper of the vehicle 200 to detect guiding elements.

The antenna array 208 may include 2 or more pairs of transmit and received antenna elements. The antenna array 208 may include at least 2 transmit and receive antenna elements. The antenna array 208 may include at least 4 transmit and receive antenna elements. The antenna array 208 may include at least 6 transmit and receive antenna elements. The antenna array 208 may include at least 8 transmit and receive antenna elements. The antenna array 208 may include at least 10 transmit and receive antenna elements. The antenna array 208 may include at least 12 transmit and receive antenna elements. The antenna array 208 may include at least 14 transmit and receive antenna elements. The antenna array 208 may include at least 16 transmit and receive antenna elements. The antenna array 208 may include at least 20 transmit and receive antenna elements.

The SPR antenna array 208 may be nominally or substantially parallel to the ground surface 206. The SPR antenna array 208 may extend parallel or perpendicular to the direction of travel of the vehicle 200. SPR signals 204 may propagate downward from the transmitting antenna elements to and/or through a surface 206. The surface 206 may be a road surface 206 under the vehicle 200. The SPR signals 204 are backscattered upwardly from the surface 206 or subsurface and may be detected by the receiving antenna elements.

Embodiments of the present invention may utilize a pattern of reflective elements on or below the surface over which the vehicle 200 travels to enable the SPR system 202 to determine an instantaneous vehicle position and monitor this position as the vehicle 200 moves. The reflective elements may reflect the SPR signals 204 more efficiently than a surface 206 without reflective elements (e.g., a roadbed or other travel surface). The reflective elements may also act as resonators, absorbing signal energy. These responses may be dependent on both the dimensions of the reflective elements and the wavelength of the radar signal. For example, maximum reflection or energy absorption may occur when an antenna has a particular orientation relative to a reflective element. The degree to which the signal return deviates from this maximum may be related to the degree to which the orientation differs from the ideal. While the magnitude of the SPR signals 204 return for a single channel may not uniquely specify a particular orientation, the combination of several readings from spaced-apart antenna elements may suffice to indicate the position of the vehicle 200 with respect to the pattern of reflective elements with precision. The precision may be enhanced, or the number of antenna elements necessary to achieve a desired level of precision may be reduced, by directing the antennas to emit SPR signals 204 at different frequencies. Emitting SPR signals 204 at different frequencies may break potential symmetries in the responses that may create ambiguity. Indeed, since the SPR antenna elements 208 emit a range of different frequencies, the dimensions of each reflective element may be tuned to different parts of the emission (e.g., one or more frequencies or harmonics). In some embodiments, the emissions pattern itself may change in a pattern-dependent fashion as the vehicle 200 moves along the pattern. For instance, upon initial detection of the reflective pattern, the emission frequencies of the various antenna elements may be set at different fixed frequencies or varied over time as the vehicle 200 traverses the reflective pattern. A potential advantage to this approach may be that it reduces the probability of a false match within a given set of patterns or reduces the complexity requirements for the pattern.

More generally, to maximize reflection and improve the signal-to-noise ratio, the reflective elements may be sized relative to the dominant radar wavelength or a fraction thereof (e.g., half or quarter wave may be most reflective). The dominant wavelength may change as noted above.

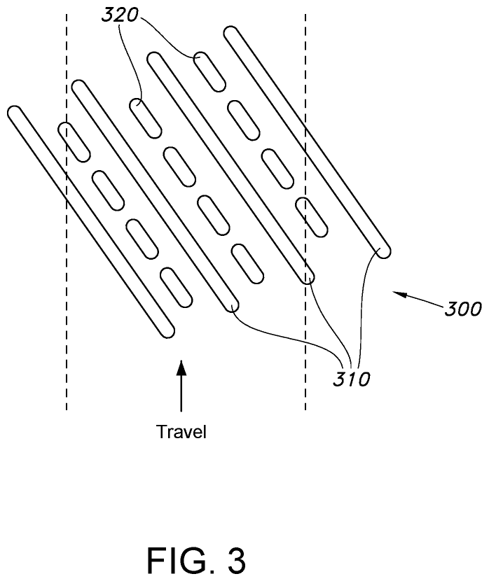

With reference to FIG. 3, a pattern 300 of reflective stripes is arranged in an off-horizontal fashion relative to the indicated direction of vehicle travel. The reflective pattern 300 may include alternating bands of long stripes representatively indicated at 310 and short stripes representatively indicated at 320. The long stripes 310 and the short stripes 320 may be parallel. In some embodiments, the pattern 300 includes non-parallel repeating features. The pattern 300 may be metal strips, wires, conductive paint, or other suitable material for interacting with radar signals and exhibiting sufficient durability for a particular application. In some embodiments, RF absorbing materials may be utilized to create the reflective pattern 300 to minimize reflections. In some embodiments, the reflective pattern 300 may be constructed using printed circuit boards. In some embodiments, there may be air or insulative gaps in the reflective pattern 300 to create a complex response.

The SPR system 202 may include vehicle operation functionality which may computationally guide the vehicle 200 to a desired position relative to the pattern 300. The SPR system 202 may cause the vehicle 200 to move over the surface 203 while analyzing the reflectively returned signals to ascertain the vehicle's 200 position relative to the pattern 300. Analyzing may include identifying peaks, nulls, and crossover points of the radar returns with respect to the stationary elements of the SPR system 202. The SPR system 202 may cause the vehicle 200 to achieve a desired position relative to the pattern 300. With reference to FIGS. 2B and 3, as the radar antenna array 208 passes over the reflective pattern 300, the return signals may be processed by the SPR system 202 to determine the location of the vehicle 200. This may include identifying peaks, nulls, and crossover points of the radar returns with respect to a geographical reference to the stationary pattern 300. In particular, each of the channels 1-11 overlies, at any moment during vehicle movement, a different portion of the pattern 300, and this is manifested in different reflection signal magnitudes (which reflect both reflection and resonance effects) returned therefrom. The SPR system 202 may determine the position of the vehicle 200 based on which antenna elements are located over long stripes 310 and short stripes 320, and how these changes as the vehicle moves relative to the pattern 300. More generally, the SPR system 202 may be calibrated by driving the vehicle 200 over the pattern 300 with absolute locations determined at intervals by mapping or physical measurement. In some embodiments, a mechanism as disclosed herein may be used to articulate the SPR system 202 forward, backward, left and/or right relative to the vehicle 200 reference frame to achieve the same result.

The SPR system 202 may include a vehicle operating system for moving the vehicle 200 into a desired location relative to the pattern 300. In some embodiments, the vehicle 200 may move forward and backwards over the pattern 300 to calibrate the SPR system 202. The SPR system 202 may locate a peak or curve fit peak during forward and backward movement of the vehicle 200 over the pattern 300. This may include methods such as threshold detection, sample—interpolate—compare, detecting the sign change of the slope of the return, or other acceptable location methods. The SPR system 202 may use the peak as an estimate of a true maximum reflection magnitude of the pattern 300 to orient the vehicle 200 relative to the pattern 300. The signal pattern associated with each ascertained location may be saved and can serve as an empirical matching template against which received signal patterns are compared to determine a location; or the signal patterns may instead serve as the basis for regression or curve fitting so that a precise location can be derived mathematically from a set of channel readings. The SPR system 202 may reference a saved location and/or a peak to determine the precise location of the vehicle 200. The SPR system 202 may compare the measured peak and the saved peak to interpolate the precise location of vehicle 200 relative to the pattern 300.

It should be stressed that the depicted pattern is exemplary only; other suitable off-diagonal patterns, such as herringbone arrangements, may also be used to advantage. It is also possible to employ reference markers (e.g., a circle or spiral that will provide a characteristic reflection signature at a particular frequency) at predetermined locations in the pattern if the entire pattern is not unique (e.g., to localize with a quadrant of the pattern).

The pattern 300 may be deployed, for example, at an electric-vehicle charging location or a parking space. The reflective stripes may encode a pattern, such as long and short lengths that are sensitive to different frequencies or harmonics emitted by a radar antenna array 208. The pattern 300 may be placed so as to detectably end when the vehicle 200 reaches the furthest extent of allowable travel, e.g., is properly positioned over a charging coil or fully within a parking space. The SPR system 202 may operate properly even if the pattern 300 is covered in water, snow, or ice.

The SPR processor 104 may include one or more modules implemented in hardware, software, or a combination of both. For embodiments in which the functions are provided as one or more software programs, the programs may be written in any of a number of high-level languages such as PYTHON, FORTRAN, PASCAL, JAVA, C, C++, C #, BASIC, various scripting languages, and/or HTML. Additionally, the software can be implemented in an assembly language directed to the microprocessor resident on a target computer; for example, the software may be implemented in Intel 80x86 assembly language if it is configured to run on an IBM PC or PC clone. The software May 10 be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

What is claimed is:

1. A positioning system for a vehicle, the system comprising:
a radar antenna array configured to transmit and receive radar signals; and
a radar operating system for (i) driving the antenna arrays to emit radar signals and receive reflection signals from a reflective pattern located beneath the vehicle and (ii) analyzing the received reflection signals to ascertain a vehicle position relative to the reflective pattern.

2. The system of claim 1, further comprising a vehicle operating system, responsive to the radar operating system, for moving the vehicle into a desired position relative to the reflective pattern.

3. The system of claim 1, wherein the reflective pattern comprises a plurality of parallel stripes angled with respect to a direction of travel of the vehicle.

4. The system of claim 3, wherein the parallel stripes include long and short lengths sensitive to different radar frequencies or harmonics thereof.

5. The system of claim 4, wherein the long and short lengths alternate across the reflective pattern.

6. The system of claim 3, wherein the parallel stripes have a length substantially equal to a dominant wavelength of the radar signals or fraction thereof.

7. The system of claim 3, wherein the parallel stripes are disposed on a surface over which the vehicle travels.

8. The system of claim 3, wherein the stripes are disposed below a surface over which the vehicle travels.

9. The system of claim 3, wherein the stripes include metallic strips.

10. The system of claim 3, wherein the parallel stripes are conductive paint.

11. The system of claim 3, wherein the parallel stripes include metamaterials.

12. A method of positioning vehicle on a travel surface, the method comprising the steps of:
transmitting radar signals toward a reflective pattern and receiving reflections signal therefrom; and
computationally guiding the vehicle to a desired position by causing the vehicle to move over the reflective pattern and, there during, computationally analyzing the received reflection signals to ascertain a vehicle position relative to the reflective pattern and responsively altering a path of the vehicle to achieve the desired position.

13. The method of claim 12, wherein the reflective pattern comprises a plurality of parallel stripes angled with respect to a direction of travel of the vehicle.

14. The method of claim 13, wherein the parallel stripes include long and short lengths sensitive to different radar frequencies or harmonics thereof.

15. The method of claim 14, wherein the long and short lengths alternate across the reflective pattern.

16. The method of claim 13, wherein the parallel stripes have a length substantially equal to a dominant wavelength of the radar signals or fraction thereof.

17. The method of claim 13, wherein the parallel stripes are disposed on a surface over which the vehicle travels.

18. The method of claim 13, wherein the parallel stripes are disposed below a surface over which the vehicle travels.

19. The method of claim 13, wherein the parallel stripes include metallic strips.

20. The method of claim 13, wherein the parallel stripes include conductive paint.

21. The method of claim 13, wherein the parallel stripes include metamaterials.
